(19) United States
(12) Patent Application Publication
(10) Pub. No.: US 2005/0256765 A1
(43) Pub. Date: Nov. 17, 2005

(54) Differentiated web advertising services in display devices

(75) Inventors: Wei-Cheng Lin, Taipei (TW); Meng-Cheng Chen, Taipei (TW); Jeng-Chun Chen, Taipei (TW)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Groenewoudseweg (NL)

(21) Appl. No.: 10/511,977

(22) PCT Filed: Apr. 1, 2003
(86) PCT No.: PCT/IB03/01423

§ 371 Date: Oct. 20, 2004

(30) Foreign Application Priority Data
Apr. 25, 2002 (EP) 02076652.3

(51) Int. Cl. G06F 17/60

(52) U.S. Cl. 705/14

(57) ABSTRACT

The present invention relates to a method of differentiating specific content in a web page displayed by a display device (109). The method comprises the steps of identifying (105) content in said web page with identification parameters comprised by a predefined set of identification parameters and of transmitting (107) information about said identified content to said display device (109). The display device (109) is adapted for displaying the content according to the information in a way, which differentiates the content from other content in the web page.

The invention relates to a method of and an apparatus for differentiating specific content in a web page. The invention further relates to a computer readable medium having stored therein instructions for causing a processing unit to execute the method and a computer readable medium having stored therein code describing a web page.

Advertisement techniques through the Internet are continuously advanced in many fields and approached from different sides accompanying rapid increase of Internet user numbers. Contrary to known advertisements by way of advertising media such as radio, TV or cable TV, advertisement on the Internet has a variety of advantages, namely that it is capable of one-to-one announcement suited to the taste of the consumer, providing consumers with information by securing distribution network for advertisement itself and by determining its effect.

Web-based commercial advertisement, like banners or icons, has therefore become essential parts in web pages. Along with the development of network and web technology, advertisements are no longer limited to still images, but have extended to animations or video clips. The underlying idea of all sorts of advertisements is to attract the users attention and to provide information that is of interest for the user.

A web page can comprise a number of different advertisements from different suppliers and because of the different interest of each user; the users are often presented with information that is not within their field of interest.

U.S. Pat. No. 5,999,912 describe a method for dynamically scheduling and displaying advertising on web pages. Specific ad locations are defined in the web page and each time the web page is to be viewed, an ad is selected from a number of ads, thereafter the selected ad is presented to the user. Thereby the number of advertisers per web page can be maximised and it makes the entire set of the web page a site more attractive to viewers since changing web pages on the Internet attracts more interest than static pages. The method, however, does not solve the problem of presenting specific advertisements to specific users in a single web page.

It is therefore an object of the present invention to provide a method, which presents a web page differently for a specific user or for a group of users.

This is obtained by a method of differentiating specific content in a web page displayed by a display device, said method comprising the steps of,
identifying content in said web page with identification parameters comprised by a predefined set of identification parameters,
transmitting information about said identified content to said display device, said display device being adapted for displaying said content according to said information in a way which differentiates said content from other content in said web page.

As web browsing becomes more and more popular, how to attract users becomes the key issue for web-based advertising. In intuition, visual characteristics (e.g. brightness) are one of the key differentiation factors among web contents. At the same time, it is common that display devices (e.g. monitors) have DSP (Digital Signal Processing) capabilities. The proposed method can differentiate web contents and attract users by leveraging functionalities of display devices.

In an embodiment the contents are advertisements, the identification parameters identify the advertisers and the predefined set of identification parameters identify a number of predefined advertisers. The proposed method can thereby differentiate ads through display device functionalities, and ads could therefore be more attractive to users in a seamless and efficient way.

In a specific embodiment the predefined advertisers are business partners of the manufacturer of said display device. This provides a prioritised scheme, which can attract business partners to e.g. the display device manufacturer.

In another embodiment the predefined advertisers have been defined according to the fields of interest of a user. Thereby a personalized scheme is provided, which can create added value to display devices. Further, the advertisers communicate with the group of potential customers who have an interest in their products.

In an embodiment the identification parameters are comprised in the code describing said web page. It is the most intuitive and efficient way to comprise identification information, comparing to digital labelling or other image processing algorithms.

In yet another embodiment the information transmitted to said display device comprises coordinates of the identified content, said coordinates identifying the area of said web page which comprises the content to be differentiated by said display device. The display devices can then easily receive transmitted information and enhance the visual quality of the specific area by means of its own DSP functionalities.

In a further embodiment the identified content is differentiated from other content in the web page by enhancing the identified content from the other content. This will give the visual differentiation between identified ads and ordinary ads, and the identified ads will thus be more attractive to users.

The invention further relates to a computer readable medium having stored therein instructions for causing a processing unit to execute the above-mentioned method. This medium can be obtained from an Internet download or from drivers along with display devices. After it is installed, it will work transparently to users.

The invention also relates to an apparatus for differentiating specific content in a web page displayed by a display device, comprising
means for identifying content in said web page with identification parameters comprised by a predefined set of identification parameters,
means for transmitting information about said identified content to said display device, said display device being adapted for displaying said content according to said information in a way differentiating said content from other content in said web page.

This apparatus will work transparently to users. The apparatus can be further extended to other devices since it plays the role as the bridge between web page information and specific devices being used for displaying the information.

The invention also relates to a computer readable medium having stored therein code which describes a web page, wherein the code further comprises identification parameters to be used for identifying specific content in said web page which is to be differentiated from other content in said web page by a display device adapted for displaying said content according to said information in a way differentiating said content from other content in said web page.

In the following preferred embodiments of the invention will be described referring to the figures, wherein

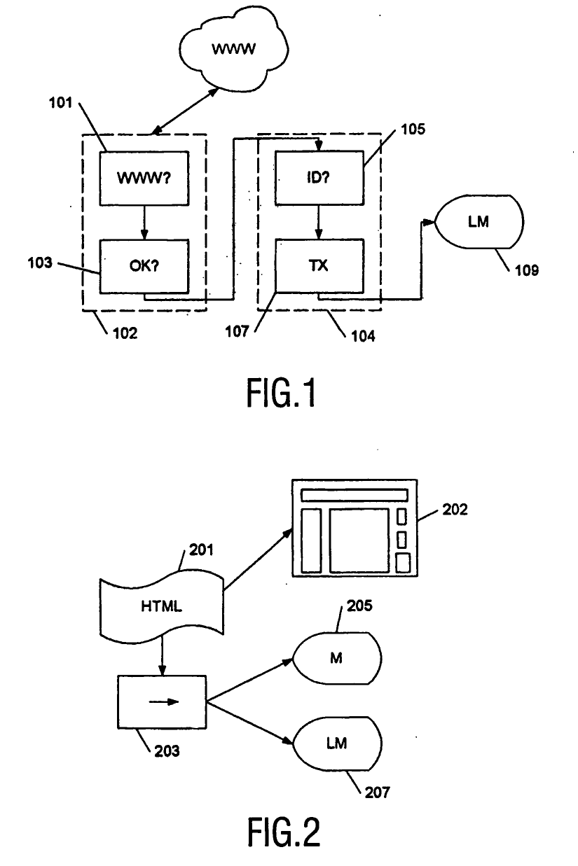

FIG. 1 illustrates a flow diagram of an embodiment of the overall idea of the present invention,

FIG. 2 illustrates an embodiment of the present invention where the web page has been implemented using HTML,

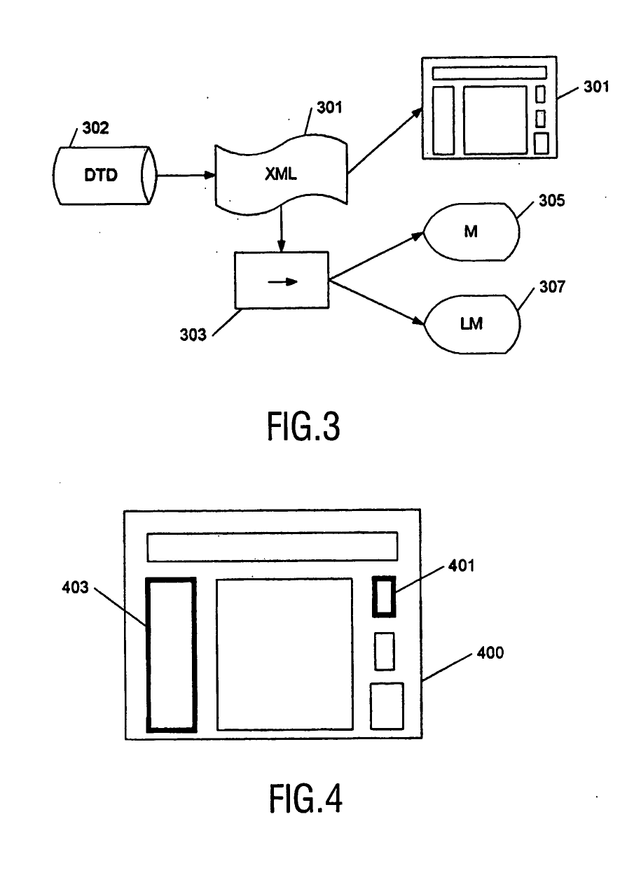

FIG. 3 illustrates an embodiment of the present invention where the web page has been implemented using XML,

FIG. 4 illustrates a web page where fields have been enhanced by the monitor displaying the web page.

In FIG. 1 a flow diagram illustrates the present invention. A web page is requested 101 from the World Wide Web by a web browser 102, the web browser could e.g. be Internet Explorer © or Netscape Navigator ©. When the web address is found, the web browser downloads a file describing the web page; this file could e.g. be a HTML file or a XML file. After the browser has completed downloading the file describing the web page, a front-end agent 104 is notified 103. The agent 104 then checks the content of the web page and determines 105 whether there is any content information of particular relevance, such as advertisements from a participating business partner. If any content information of particular relevance is present e.g. identified by an identifier 105 looking for specific ID information placed in the web page, the coordinates of the content are extracted and transmitted 107 to the display device 109, such as a LightFrame Monitor (LM). The display device uses this information to differentiate the identified content, e.g. by sharpening the content on the display or by brightening the content.

The functionality described above could e.g. be placed in a separate front end program which can be installed on top of the browser as an additional program; in this case the program could be downloaded from the Internet e.g. from the homepage of the manufacturer of the display device. The program could alternatively be supplied with the display device on a storage medium, e.g. on a storage medium which also comprises the display device drivers. The program could be adapted to determine content on the web page which is advertising content; this advertising content could be advertising banners comprising still images, animations or video. The program could e.g. be adapted for selecting advertising banners from advertisers according to a predefined list of advertisers, which could be partners of the manufacturer of the display device, or alternatively the list could be defined according to the interests of the user reading the web page. In an alternative embodiment the functionality of the front end is an integrated part of the web browser.

Further the functionality could be personal, meaning that e.g. the front-end program is adapted for selecting advertising banners lying within a field of interest defined by the user. The user could e.g. define the interests in a questionnaire manually or by using the web page of a service provider and then according to the interests a front-end program is send to the user which is then installed on top of the browser. Further, the front-end program could be personalised locally by the user. This could be done by defining the area of interest when installing the front-end program or when running the front-end program the first time.

In FIG. 2 an embodiment is shown where the web page 202 is described as an HTML file 201. In sub parts of the HTML file, specific content is placed and this content is identified using a parser 203 for detecting predefined attributes or tags in the code of the HTML file describing the content, such as advertising content. The information identifying the content then identifies an advertiser and if the advertiser is an advertiser of interest e.g. an advertiser being a partner of the display device manufacturer, then content data describing the display region of the content is extracted/calculated and these content data are send to the display device 207 such as a LightFrame © monitor (LM), which then differentiates this specific area on the display when displaying the web page. If the display device is a device 205, which is incapable of differentiating specific areas, then the parser ignores the predefined attributes or tags and the web page is displayed in a conventional way 205.

The display device which is able to differentiate specific areas could e.g. be a display device such as a LightFrame © display device from Philips which can highlight specific areas on the display.

In FIG. 3 an embodiment is shown where the web page 304 is described as an XML file 301 combined with the definitions in the locally stored DTD file 302, in sub parts of the XML file, specific content is placed and this content is identified using a parser 303 for detecting predefined attributes or tags in the code of the XML file describing the content, such as advertising content. The information identifying the content then identifies an advertiser and if the advertiser is an advertiser of interest e.g. an advertiser being a partner of the display device manufacturer, then content data describing the display region of the content are extracted/calculated and these content data are send to the LightFrame monitor 307, which then differentiates this specific area on the display when displaying the web page 301. If the display device is a monitor, which is incapable of differentiating specific areas, then the parser ignores the predefined attributes or tags and the web page is displayed in a conventional way.

When using XML or HTML, the ID information could e.g. be provided by a HTML or XML tag placed in connection with the content data. The tag could then be used to identify information such as type of content identifying how to display content. The identified type of content could also be used to identify the priority or the advertisement category.

In FIG. 4 a web page 400 is shown comprising a number of fields. In this example the fields 401 and 403 have been enhanced by e.g. the LightFrame monitor displaying the web page. The enhanced fields 401 and 403 have been identified as explained in connection with FIG. 1.

The method can be implemented in computer readable code. This computer readable code can be downloaded into the general purpose memory of a personal computer or similar computing device. Downloading can be done by means of a connection to the internet or by making use of a conventional way of downloading computer readable software like for example from a compact disk.

1. A method of differentiating specific content in a web page displayed by a display device, said method comprising the steps of,
identifying content in said web page with identification parameters comprised by a predefined set of identification parameters,
transmitting information about said identified content to said display device, said display device being adapted for displaying said content according to said information in a way which differentiates said content from other content in said web page.

2. A method according to claim 1, wherein said content is advertisements and said identification parameters identify the advertisers and wherein said predefined set of identification parameters identifies a number of predefined advertisers.

3. A method according to claim 2, wherein said predefined advertisers are business partners of the manufacturer of said display device.

4. A method according to claim 2, wherein said predefined advertisers have been defined according to the field of interests of a user.

5. A method according to claim 1, wherein said identification parameters are comprised in the code describing said web page.

6. A method according to claim 1, wherein the information transmitted to said display device comprises coordinates of the identified content, said coordinates identifying the area of said web page which comprises the content to be differentiated by said display device.

7. A method according to claim 1, wherein the identified content is differentiated from other content in the web page by enhancing the identified content from the other content.

8. A computer readable medium having stored therein instructions for causing a processing unit to execute the method of claim 1.

9. An apparatus for differentiating specific content in a web page displayed by a display device, comprising
means for identifying content in said web page with identification parameters comprised by a predefined set of identification parameters,
means for transmitting information about said identified content to said display device, said display device being adapted for displaying said content according to said information in a way differentiating said content from other content in said web page.

10. A computer readable medium having stored therein code which describes a web page, wherein the code further comprises identification parameters to be used for identifying specific content in said web page which is to be differentiated from other content in said web page by a display device adapted for displaying said content according to said information in a way, which differentiates said content from other content in said web page.
